(19) United States
(12) Patent Application Publication
(10) Pub. No.: US 2017/0241408 A1
(43) Pub. Date: Aug. 24, 2017

(54) MULTI-TURBINE WIND POWER PLATFORM FOR OFFSHORE APPLICATIONS

(71) Applicant: HEXICON AB, Stockholm (SE)

(72) Inventor: Fredrik VON HELAND, Saltsjöbaden (SE)

(73) Assignee: HEXICON AB, Stockholm (SE)

(21) Appl. No.: 15/324,625

(22) PCT Filed: Jun. 25, 2015
(86) PCT No.: PCT/SE2015/050740

§ 371 Date: Jan. 6, 2017

(30) Foreign Application Priority Data
Jul. 11, 2014 (SE) 1450889-9

(51) Int. Cl. F03D 13/25; B63B 35/44; F03D 7/02

(52) U.S. Cl. CPC F03D 13/25; F03D 7/0204; B63B 35/44; F05B 2240/93; F05B 2240/96; B63B 2035/446

(57) ABSTRACT

A floating multi-turbine wind power platform for offshore power production, wherein the platform has a substantially elongated shape with an extension direction and being attached to at least two mooring points for securing the platform at its operation site in an original position in relation to the mooring points. The platform includes a device for rotation of the platform (MR1) around an essentially vertical first axis (z1) and further includes at least two wind turbines arranged substantially in a straight line corresponding to the extension direction of the platform and the at least two wind turbines each includes a structural support component and a rotor component. The rotor component is attached to a nacelle which is arranged to rotate using a device for rotation of the nacelle (MR2). The platform further includes a control arrangement (C) arranged to control the device for rotation of the platform (MR1) to rotate the platform only during certain detected wind directions deviating from an original wind direction (WDO) and to limit the rotation of the platform to at the most 90° from the original position, preferably at most ±45°. A method and system are disclosed for aligning rotor components of wind turbines arranged on a floating multi turbine wind power platform according to the above to be essentially perpendicular to a wind direction.

### TECHNICAL FIELD

The present invention relates generally to a floating multi-turbine wind power platform for offshore power production.

### BACKGROUND ART

Solutions for production of renewable energy in offshore environments are subject to severe weather conditions making assembly and maintenance difficult tasks. In order to sustain forces applied by weather conditions it is essential that offshore structures are rigid structures. In addition it is common that offshore structures are of a significant size both due to the construction requirements and the application areas. In prior art it is known to arrange wind turbines in offshore environments to utilize the often beneficial wind conditions for power production.

The prior art presents different solutions relating to arrangement of wind turbines that are commonly used and known to the person skilled in the art. For example, wind turbines are scattered in patterns on individual platforms or foundations in the ocean or on large platforms hosting multiple wind turbines. The platforms of the prior art are designed either to host a single wind turbine or in a way that the wind turbines are arranged on a platform wherein the wind approaches the platform from a substantially constant direction because the entire platform is rotated to align with the wind.

Interference between wind turbines is created by wakes generated behind the rotor component, i.e. the rotor blades, of the wind turbine. The wakes are turbulence created from the rotation of the rotor component and extend backwards a significant distance from the wind turbine. The turbulence of the wakes is decreasing with the distance from the turbine.

In order to avoid interference between wakes and wind turbines, the wind turbines are in general arranged with significant distances from each other that prevent such interference. When applied in an offshore environment this generates significant size requirements for multi-turbine wind platforms.

In prior art it is further well known to arrange a wind turbine, a structural support component, a rotor component, a generator component, and a nacelle, wherein said nacelle is arranged on said structural support component, and the nacelle is adapted to rotate in order to align the rotor component with the wind. Although some wind directions are more common than other it is beneficial to allow a wind turbine to be functional independent of the wind direction through the nacelle rotation which is possible through the aforementioned design. The different wind directions generate the problem that the distance between the wind turbines is required to be at least the required distance from the least favorable wind direction due to the risk of increased wear and lost power production if interference occur. This means that if wind turbines are distributed in an elongated line in relation to each other the distance between the wind turbines are required to exceed the interference range, i.e. the range outside which the wake has decreased enough for a new turbine operate beneficially.

One solution to this problem presented by prior art is platforms of round, hexagon, or triangular form which are rotatable 360° around a central axis. The distance between the wakes and other rotor components are thereby maintained at a constant length independent of the wind direction. Thereby is the minimum distance utilized between all the wind turbines creating a relatively space efficient solution. However, such designs still require platforms of significant sizes with production methods that can be improved. For example, during production of multi-turbine wind power platforms standard shipyard docks are utilized for production of the individual parts. Completion of the platforms however cannot be conducted within such docks due to the size and form of the platform which in the aforesaid solutions is significantly different from the form factor and shape of a conventional ship.

This is a problem which is addressed by the prior art in a non-beneficial way by utilization of a solution wherein the platforms is removed from the shipyard dock and placed in calm waters for final assembly. Performing of assembly outside a controlled area, such as a dock, increases the risk associated with the operation significantly. Risks include for example bad weather, bad working conditions, difficult operations, and limited access to cranes and tools. In addition to the increased risks, the method of assembly also contributes to increased demands on tolerances in the initial production.

The solutions as presented by the prior art furthermore comprises multiple additional drawbacks. Upon completion of platforms of any type it is necessary to relocate the platform to the final production site. The final production sites are offshore locations and the general process is that the platform is towed into position by one or more tug boats. This is a delicate process associated with large costs and risks which in general are time dependent. The transportation time is proportional to the risk factor due to lost production time and the risk of changing weather conditions. As the person skilled in the art appreciates it is in general difficult to tow a round, triangular, or hexagon structure through the water simply due to its shape. The structures known in prior art are thereby limited in relation to the speed that they can be towed in.

In addition to low transportation speeds many commercial sea routes comprise width limitations for vessels passing through, for example the Suez Canal and the Panama Canal which are too narrow for conventional wind turbine platforms to pass through. This increase the relocation time for platforms traveling in waters where those channels otherwise could be utilized.

In light of the aforementioned problems and prior art solutions it would be advantageous to provide an offshore wind turbine platform that addresses at least some of the identified limitations without compromising the multi-turbine design advantages.

### SUMMARY OF INVENTION

An object of the present invention is to provide an offshore multi-turbine wind power platform for power production that have its wind turbines arranged in a space saving manner preventing wake interference while not exceeding the maximum width requirements of general purpose shipyard docks and commercial sea routes.

These objects are achieved by the multi-turbine wind power platform, method and system as set forth in the appended claims.

Thus, the invention relates to a floating multi-turbine wind power platform for offshore power production, wherein said platform is having a substantially elongated shape with an extension direction and being attached to at least two mooring points adapted to secure the platform at its operation site in an original position in relation to said mooring points by means of attachment means connected to said platform in at least two platform connection point. Said platform comprises means for rotation of the platform around an essentially vertical first axis and further comprise at least two wind turbines arranged substantially in a straight line corresponding to the extension direction of the platform and said at least two wind turbines each comprises a structural support component and a rotor component arranged to rotate around an essentially horizontal axis. Said rotor component is attached to a nacelle which is arranged to rotate around an essentially vertical second axis using means for rotation of the nacelle. The invention is characterized in that the platform comprises a control arrangement arranged to control the means for rotation of the platform to rotate the platform only during certain detected wind directions deviating from an original wind direction defined as a direction being essentially perpendicular to the elongation direction of the platform when in the original position and to limit the rotation of the platform to at the most 90° from the original position, preferably at most ±45°.

In one embodiment, said means for rotation of the nacelle and the means for rotation of the platform is adapted to cooperate to align the rotor components of the wind turbines to be essentially perpendicular to a detected actual wind direction. The control arrangement may in one embodiment be used to control both the means for rotation of the platform and the means for rotation of the nacelles.

Hereby, the platform and nacelles is adapted to rotate to prevent interference between wakes created behind said rotor components and the rotor components of the nearby arranged wind turbines. The platform is adapted to be rotated between approximately ±45° from said original platform position in order to enable coverage of all wind directions without interference between wakes. However, a smaller rotation angle is also possible. By rotation of both the platform and the nacelles, the rotation of the nacelles are limited to degrees wherein their wakes are not brought into interference with the rotor components of the neighboring wind turbines on the floating multi-turbine wind power platform. As previously described this is achieved by a combination of rotating the nacelle and the platform. The rotation of the platform is based in a plane which is substantially parallel to the surface of the water in which the platform floats and the rotation of the nacelles is based in a plane parallel to the rotation plane of the platform.

One advantage with limiting the rotational freedom of the platform to in total 90° is that multiple mooring points can be used without advanced rotational means attached to the platform. For example, if the platform should rotate 360° the moorings have to be flexible in a way that the platform can rotate around its own axis without movement of the moorings. This creates problems and adds significantly more complicated solutions in order to achieve the purpose. By limiting the rotation of the platform fixed moorings with attachment means of a fixed length can be used without any of the aforementioned problems.

In one embodiment of the platform, the means for rotation of the nacelle or the means for rotation of the platform is adapted to solely be used or used together for aligning the rotor components of the wind turbines to be essentially perpendicular to the actual wind direction, when the wind blows from wind directions within a first sector defined as approximately ±45° from the original wind direction or a second sector defined as approximately 135°-225° from the original wind direction and wherein the means for rotation of the nacelle is adapted to be used together with the means for rotation of the platform for aligning the rotor components of the wind turbines to be essentially perpendicular to the actual wind direction, when the wind blows from wind directions within a third sector defined as approximately 45°-135° from the original wind direction and a fourth sector defined as approximately 225°-315° from the original wind direction, so that said platform rotates a maximum of 90°, preferably at most approximately ±45°, from the original platform position and the nacelle rotates the remaining degrees until the rotor components are aligned to be essentially perpendicular to the actual wind direction.

For an original position of the nacelles at 0°, i.e. essentially parallel to the extension direction of the platform, when the wake direction is substantially perpendicular to the platform and the wakes are parallel to each other the risk of interference is very limited. The wakes are directed backwards from a rotor component centrum aligned in a straight line directly behind the different wind turbines. Upon rotation of the nacelles the risk of interference increases with the angle deviation from the original wind direction and finally peaks at 90° wherein the wake of a first wind turbine is directed directly towards a second wind turbine, the second wind turbine is directed directly towards a third, and so on. When combining a rotation of the nacelle and the platform this interference may be avoided.

The first and second sectors are corresponding to each other and are reached through solely nacelle rotation meaning that the nacelle is the only part of the multi-turbine wind power platform that is aligned towards the wind for those sectors. The first and second sectors may also be reached through solely platform rotation, meaning that only the platform rotates and the nacelles remain in their original position with the rotor components essentially aligned with the elongation direction of the platform. In one embodiment, it is of course also possible to reach the first and second sectors through a combination of nacelle and platform rotation, for example by rotating the nacelle 5° and the platform 10°. The third and fourth sectors are also corresponding sectors in relation to each other and are reached through a combination of nacelle rotation and platform rotation. In so doing the rotation of the nacelles are never more than 45° from an original position at 0° or more than 45° from a position at an offset of 180° from an original position. Thereby the nacelles avoid the rotation ranges 46° to 134° and 226° to 314° from an original position which enables that the wind turbines are placed closer together. In combination with the rotation of the platform it is despite the limited rotation possible to reach all 360° of possible wind directions.

In one embodiment of the floating multi-turbine wind power platform for offshore power production said means for rotation of the platform comprises at least two winches arranged to move at least one platform connection point along the length of said attachment means. The platform is rotated in a plane substantially parallel to the water surface through the winches moving the platform connection points along the length of said attachment means.

When the wind direction changes the rotor components are aligned with the new wind direction through either rotation of the nacelle, the platform, or a combination thereof. In one embodiment of the floating multi-turbine wind power platform the rotation of the platform is conducted through winching the platform into new positions in relation to the original platform position. The platform connection points are the points on the attachment means that currently are in engagement with the platform through for example winches. The connection points may be points on the attachment means that are moved depending on the platforms position when the winches move the platform between different positions.

In one embodiment of the floating multi-turbine wind power platform for offshore power production said platform is attached to said moorings through attachment means of a constant length.

Another advantage with the present invention is that attachment means, such as cables, wires, chains, or any other form of attachment means, of a constant length can be utilized to secure the platform at its production site. In relation to prior art solutions it is thereby possible to reduce the required length of the attachment means as well as reduce the need for storage on the platform. This further has the effect that less salt water contaminated attachment means are stored on the platform reducing the risk for corrosion and mechanical failure.

In one embodiment of the floating multi-turbine wind power platform for offshore power production is a truss structure comprising at least two spaced apart substantially elongated pontoon bars attached to a lower section of said platform, said elongated pontoon bars are enlarged to act as floatation pontoons during transportation and/or maintenance.

One advantage with the present invention is that the elongated shape makes the platform sufficiently easier to tow through the water by for example a tug boat than the prior art solutions. In order to further enhance this functionality the truss structure of the floating multi-turbine wind power platform has been developed to comprise at least two enlarged pontoon bars arranged in the lower parts of the platform truss structure. The platform is designed to be stable both with ballast and without which means that for transportation the ballast can be reduced, or eliminated, resulting in that the platform floats higher in the water. Through changing the buoyancy of the platform it is possible to achieve a transportation mode wherein the platform solely floats on the two, or more, enlarged pontoon bars. This reduces the water resistance and the enlarged pontoon bars are utilized as floatation pontoons similar to the construction of a multi-hull vessel, such as a multi-hull boat.

In one embodiment of the floating multi-turbine wind power platform for offshore power production the enlarged pontoon bars further are adapted to act as ballast tanks.

Another advantage with the floating multi-turbine wind power platform in accordance with the present invention is that the abovementioned enlarged bars further functions as ballast tanks which may be filled with either air or water depending on the preferred buoyancy of the platform. This can be utilized for transportation as described in the embodiment above but also for example when conducting maintenance operations to the platform. As previously mentioned the enlarged bars works as pontoons lifting the platform out of the water. This means that access can be granted to substantially all parts of the platform without removing it from the production site.

The person skilled in the art understands that the ballast tanks, i.e. the pontoon bars, in another embodiment might be filled partly or in total with any other form of ballast material.

In one embodiment the ballast is required in order to enable power production due to the forces exerted on the structure by the wind turbines.

In one embodiment of the floating multi-turbine wind power platform for offshore power production the space between the adjacent wind turbines is between one and three times the rotor component diameter, preferably 1.55 times the rotor diameter.

Through the aforementioned benefits of the floating multi-turbine wind power platform the distance between the wind turbines comprised at said platform can be reduced without the requirement of rotating the platform 360°. In prior art solutions wherein only nacelle rotation is utilized it is common with distances such as five times the rotor component diameter while the present solution enables the wind turbines to be mounted at for example 1.55 times the rotor component diameter.

In one embodiment of the multi-turbine wind power platform for offshore power production the width, beam and draught, of said platform is within the limits of Suezmax, preferably within the limits of Panamax.

Suezmax and Panamax are naval architecture terms defining the largest measurements that are allowed to transit through the Suez Canal and Panama Canal respectively. The terms are collective terms for the length, width and draught, of vessels that are allowed for transit.

The invention further relates to a method for aligning rotor components of wind turbines arranged on a floating multi turbine wind power platform as described above, to be essentially perpendicular to a wind direction. The method comprises the steps of:
Determining an actual wind direction
Relating said actual wind direction to an original wind direction defined as a direction being essentially perpendicular to the elongation direction of the platform when in the original position
Controlling the rotation of said platform based on the actual wind direction and limiting the rotation of the platform to at the most 90° from the original position, preferably at most ±45°
Aligning the rotor components of the wind turbines to be essentially perpendicular to the actual wind direction using the means for rotation of the nacelle and/or the means for rotation of the platform.

In one embodiment of the method, it further comprises the steps:
when the wind blows from wind directions within a first sector defined as ±45° from the original wind direction or a second sector defined as 135-225° from the original wind direction; using means for rotation of the nacelle (MR2) to rotate only the nacelle or using means for rotation of the platform (MR1) to rotate only the platform or use both the means for rotation of the nacelle (MR2) and the means for rotation of the platform (MR1) to align the rotor components to be essentially perpendicular to the wind direction
when the wind blows from wind directions within a third sector defined as 45-135° from the original wind direction and a forth sector defined as 225-315° from the original wind direction; using means for rotation of the nacelle together with means for rotation of the platform to rotate the platform a maximum of 90°, preferably at most ±45°, from the original platform position and rotating the nacelle the remaining until the rotor components are aligned to be essentially perpendicular to the wind direction.

In one embodiment of the method, said method further comprises the step of:
winching said platform along the attachment means and thereby rotating the platform.

Another aspect of the invention is a system for aligning rotor components of wind turbines arranged on a floating multi turbine wind power platform as described above, to be essentially perpendicular to a wind direction. The system comprises, means for determining an actual wind direction, means for relating said actual wind direction to an original wind direction defined as a direction being essentially perpendicular to the elongation direction of the platform when in the original position, means for controlling the aligning of the rotor components of the wind turbines to be essentially perpendicular to the actual wind direction by controlling the means for rotation of the nacelle and/or the means for rotation of the platform.

The above system is able to be used to rotate a floating multi-turbine wind power platform so that each individual wind turbine always operate in free wind avoiding interference between wakes, without using complicated mooring devices allowing a 360 degree rotation of the platform. Thus, the system enable a more effective wind power production using a wind power platform which is cost efficient to produce and to transport to and attach at its desired location at sea. Said means for controlling the aligning of the rotor components and/or the means for rotation of the platform may in one embodiment be the above described control arrangement.

In order to further clarify the multi-turbine wind power platform for offshore power production and method of aligning it the original platform position wherein the platform is at a central position has been defined as the original platform position. Thus, this is the position wherein the platform is originally securely moored into and in one preferred embodiment the position wherein the distance to the different mooring points is substantially the same, the middle position of the rotation range, or the position wherein the attachment means are winched to their center position at the platform. The original platform position is not related to any compass bearing and can be in any orientation relating thereto. However, for the purpose of this description the original platform position is also referred to as 0° from the original platform position.

### BRIEF DESCRIPTION OF DRAWINGS

The invention is now described, by way of example, with reference to the accompanying drawings, in which:

FIG. 1 illustrates an isometric view of one embodiment of the floating multi-turbine wind power platform.

FIG. 2 illustrates an isometric view of the floating multi-turbine wind power platform comprising two enlarged pontoon bars.

FIG. 3 shows an isometric view of the floating multi-turbine wind power platform illustrating the wakes that are formed behind the rotor components.

FIG. 4 illustrates one embodiment of the floating multi-turbine wind power platform wherein the wind direction is within the first sector at 0° from an original wind direction.

FIG. 5 illustrates one embodiment of the floating multi-turbine wind power platform wherein the wind direction is within the first sector at ˜−45°/315° from an original wind direction.

FIG. 6 illustrates one embodiment of the floating multi-turbine wind power platform wherein the wind direction is within the fourth sector at ˜270° from an original wind direction position.

FIG. 7 illustrates one embodiment of the floating multi-turbine wind power platform wherein the wind direction is within the second sector at ˜225° from an original wind direction position.

FIG. 8 illustrates one embodiment of the floating multi-turbine wind power platform wherein the wind direction is within the second sector at ˜180° from an original wind direction position.

FIG. 9 illustrates one embodiment of the floating multi-turbine wind power platform wherein the wind direction is within the second sector at ˜135° from an original wind direction position.

FIG. 10 illustrates one embodiment of the floating multi-turbine wind power platform wherein the wind direction is within the third sector at ˜90° from an original wind direction position.

FIG. 11 illustrates one embodiment of the floating multi-turbine wind power platform wherein the wind direction is within the first sector at ˜45° from an original wind direction position.

FIG. 12 illustrates one embodiment of a floating multi-turbine wind power platform wherein several mooring points are illustrated.

FIG. 13 illustrates one embodiment of the multi-turbine wind power platform wherein the platform is rotated from an original platform position by means of connection means to several mooring points.

FIG. 14 illustrates a principal sketch of the four sectors in relation to the wind turbine.

FIG. 15 illustrates one embodiment of the floating multi-turbine wind power platform in a conventional dry dock for ships.

### DESCRIPTION OF EMBODIMENTS

In the following, a detailed description of the different embodiments of the invention is disclosed under reference to the accompanying drawings. All examples herein should be seen as part of the general description and are therefore possible to combine in any way in general terms. Individual features of the various embodiments and methods may be combined or exchanged unless such combination or exchange is clearly contradictory to the overall function of the floating multi-turbine wind power platform and alignment method.

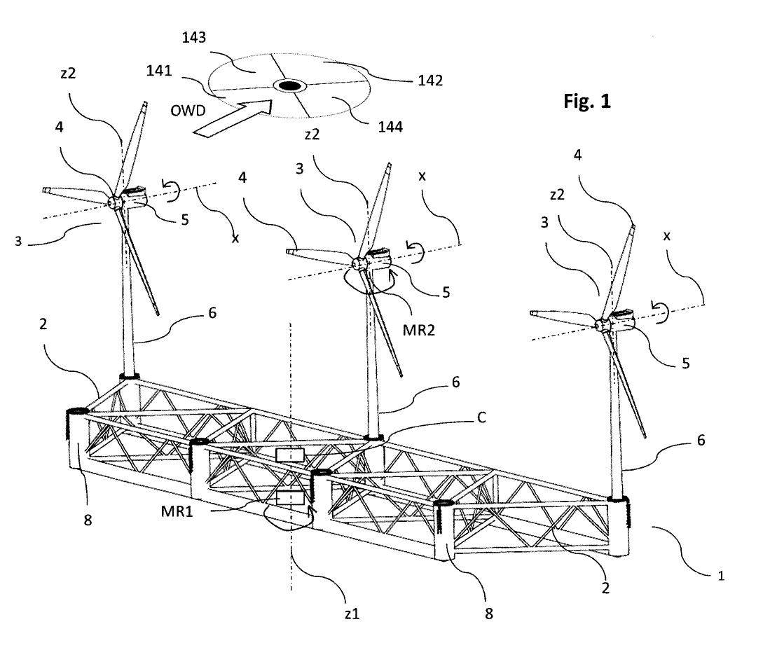

FIG. 1 illustrates one embodiment of the multi-turbine wind power platform 1 wherein three wind turbines 3 are arranged on an elongated or a substantially elongated platform 1 with a defined extension direction. The platform comprises means for rotation of the platform MR1 around a first essentially vertical axis z1. The platform 1 further comprises a control arrangement C arranged to control the means for rotation of the platform MR1 to rotate the platform only during certain detected wind directions. The control arrangement C may be an arrangement for example controlled by a central computer, located on the platform or remote from the platform, receiving signals about for example wind direction, wind strength or other weather conditions. The platform 1 has a truss structure comprising multiple bars 2 that together create the floating structure that supports said wind turbines 3.

The wind turbines are arranged on the platform through a structural support component 6 which are the supporting component that supports a nacelle 5 to which a rotor component 4 is connected and arranged to rotate around an essentially horizontal axis x. The rotation of the nacelle 5 may also in one embodiment be controlled by the control arrangement C. The support component 6 is part of the wind turbine and can for example in one embodiment be a pillar supporting a generator component, nacelle, and rotor component in the same way as conventionally known in the art. As known to the person skilled in the art the conventional pillar is round of a slightly conical shape. In another embodiment of the floating multi-turbine platform the pillar is part of the truss structure and thereby completely integrated to the structure of the platform. The person skilled in the art understands that, although the structural support component is of high significance for the function of the multi-turbine wind power platform, the design of the structural support component may be of any form or shape within the scope for the multi-turbine wind power platform as claimed herein.

The rotor component 4 is typically a three rotor blade fan with a horizontal axis x arranged at the top of the structural support component 6 creating a wind power turbine tower. The person skilled in the art understands that the rotor component can be any form of rotor component with similar characteristics, not limited to a specific number of rotor blades or a specific design.

The wind turbines are arranged on the platform in order to generate power and are thus arranged in a way that they are adapted to generate power from the wind. The rotor component 4 is attached to a nacelle 5 housing the generator component which converts the mechanical energy produced by the rotating blades of the rotor component 4 into electrical energy for use in an external circuit. The generator component is located within the nacelle and does in a typical embodiment comprise a gearbox, a generator, connection means in between, as well as connection means to the rotor component. The generator component can be of any size, gear ratio, and shape and in different embodiments located in different parts of the wind turbine.

The nacelle 5 is rotatably arranged on said structural support component 6 and arranged to rotate around a second essentially vertical axis z2 extending through the center of support component 6. Said rotation of the nacelle 5 is created by means for rotation of the nacelle MR2. Said means for rotation of the nacelle MR2 comprises a yaw motor and a yaw drive arranged to rotate the nacelle 360° around the second vertical axis z2. The nacelle 5 can be said to have an original position with a 0° rotation, when the rotating blades of the rotor component 6 are parallel to the elongation direction of the platform. The nacelle rotates in relation to the platform 1 to adjust the rotor blades to be essentially perpendicular to the wind direction.

The wind direction may be defined as a deviation from an original wind direction OWD. The original wind direction OWD may be defined as a direction being essentially perpendicular to the elongation direction of the platform when in an original position. The original position may be defined as the position where the platform is originally securely moored into the ocean bottom and in one preferred embodiment the position wherein the distance to the different mooring points is substantially the same, the middle position of the rotation range, or the position wherein the attachment means are winched to their center position at the platform. The original platform position is not related to any compass bearing and can be in any orientation relating thereto.

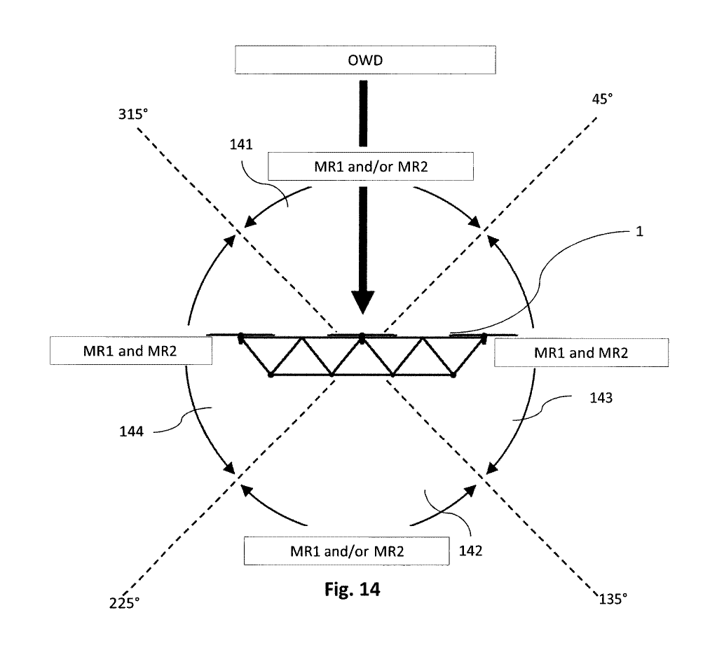

In FIG. 1 several different wind directions are visualized as sectors 141-144 of a virtual circle in relation to the original wind direction OWD. The first sector 141 is defined as ±45° from the original wind direction, the second sector 142 defined as 135°-225° from the original wind direction, the third sector 143 defined as 45°-135° from the original wind direction and the fourth sector 144 defined as 225°-315° from the original wind direction. This is further described in FIG. 14 and in the text below.

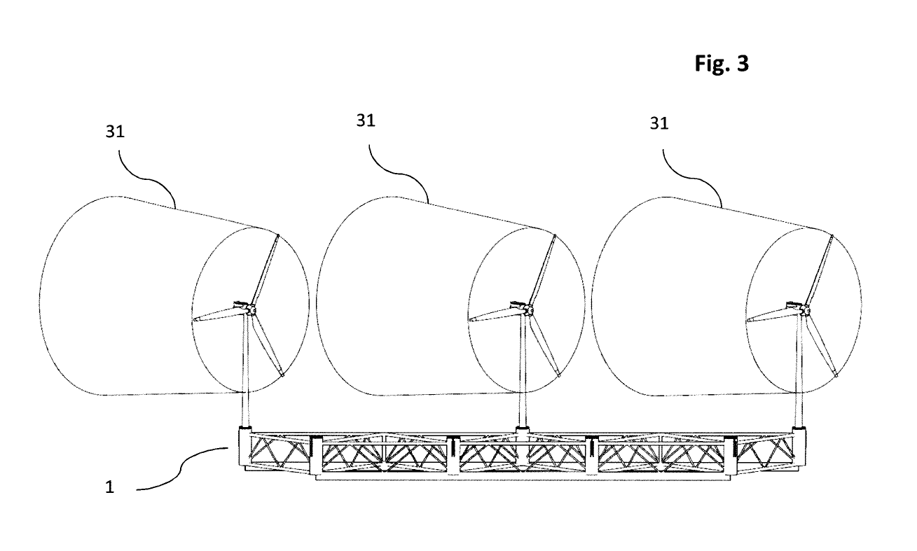

Turbulence is created from the movement of the rotor components 4. Such turbulence is in the art called wakes 31 and is formed in conical shapes behind the rotor components 4 of the wind turbines, see FIGS. 3-11. It is important that the wakes 31 from different wind turbines do not interfere with rotor components of the nearby turbines since such interference may cause severe damage over time and result in total power production failure.

As also can been seen in FIG. 1, the wind turbines 3 are placed at a distance from each other corresponding to the rotor component diameter times between one and three in order to minimize the required space while avoiding interference. This distance is different from prior art solutions wherein the distance between the wind turbines has been based on the prerequisite that the nacelle 5 should be rotatable 360° without any interference occurring between wakes and rotor components.

A 360° rotation of the nacelle 5 is possible, as is standard. However, the generation of electrical energy is preferably only activated when the nacelle 5 is rotated so that the wakes 31 from different wind turbines do not interfere with the rotor components of the nearby turbines. In one embodiment the generation of energy is only activated when the platform is rotated ±45° from the original platform position. Due to the present solution, where power is only extracted during a specific limited nacelle rotation angle interval, a system is created wherein wakes behind said rotor components 4 don't create interference, as will be explained below.

In one embodiment, the multi-turbine wind power platform 1 further comprises structural support pillars 8 that are arranged substantially vertical within the truss structure 2. The structural support pillars 8 are in one embodiment arranged along the outer edges of the truss structure 2 and arranged in a way that half, or less than half, of the structural support pillars 8 are adapted to support wind turbines 3. In a further embodiment the remaining structural support pillars 8 that do not support wind turbines 3 host service/maintenance platforms, helicopter platforms, or any other function that eases maintenance, production, or access to the multi-turbine wind power platform 1.

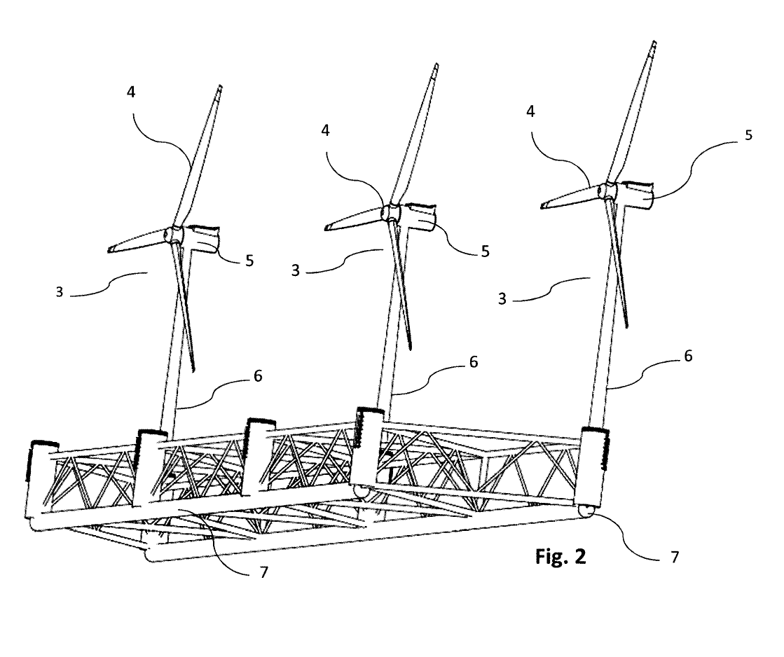

FIG. 2 illustrates one embodiment of the present invention wherein enlarged bars 7 are arranged in the lower part of the platform 1. The enlarged bars 7 are elongated enlarged bars 7 that run along the lower sections of the platform 1 creating enlarged pontoon bars 7.

During transportation of the platform 1 it is beneficial to decrease the amount of ballast water within the structure in order to decrease the underwater body of the platform assembly. Even with the ballast water removed from the platform 1 the structure is still not ideal to be towed through the water and offers high amount of water resistance. In order to address this issue the truss structure 2 comprises two spaced apart substantially elongated pontoon bars 7 attached to the lower sections of said platform. Those elongated pontoon bars 7 are enlarged to act as floating pontoons 7 during transportation. This means that when the amount of ballast in the platform is decreased the platform buoyancy changes causing the platform to float at a level wherein only the two pontoon bars 7 are in direct contact with the surface of the water, thereby creating a solution wherein the water resistance is reduced and the platform floats like a multi-hull vessel.

The person skilled in the art understands that the number, length, shape, form, and size of the pontoon bars 7 may change for different embodiments of the invention. In one preferred the truss structure is created by round bars 7 connected to each other. However, it is understood that any form of bars in any suitable material such as metal, aluminum, composite materials, or any other suitable material could be used to create the structure. The structure could thereby for example consist of round bars, rectangular bars, or any other shape of bars.

FIG. 3 illustrates an isometric view of the multi-turbine wind power platform 1 for offshore power production wherein the turbulence or wakes 31 created from the movement of the rotor components 4 is illustrated. The wakes 31 are formed in conical shapes behind the rotor components 4 of the wind turbines. It is important that the wakes 31 from different wind turbines do not interfere with rotor components of the nearby turbines since such interference may cause severe damage over time and result in total power production failure.

As previously disclosed this is one of the reason for the design of the prior art arrangements wherein for example triangular platforms have been used in order to create a stable platform without compromising the required space between the wind turbines.

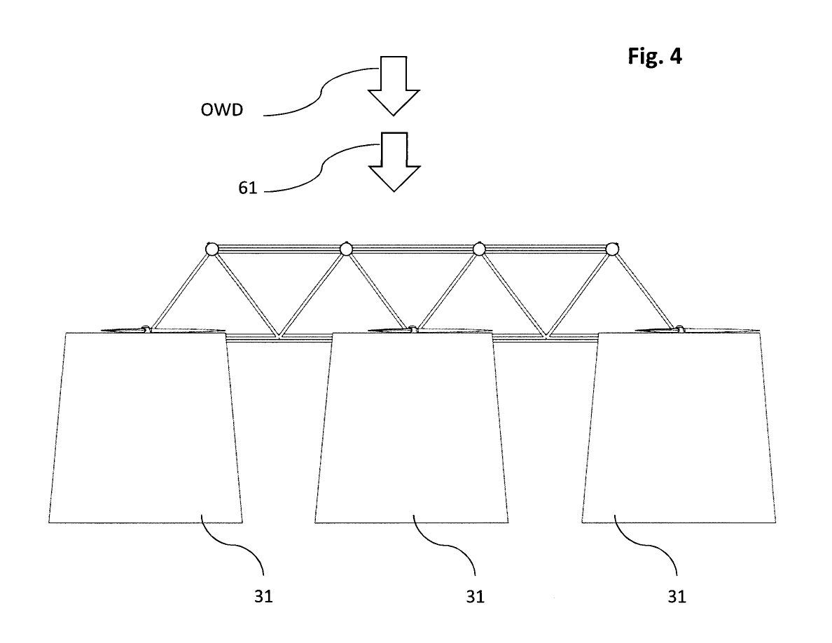

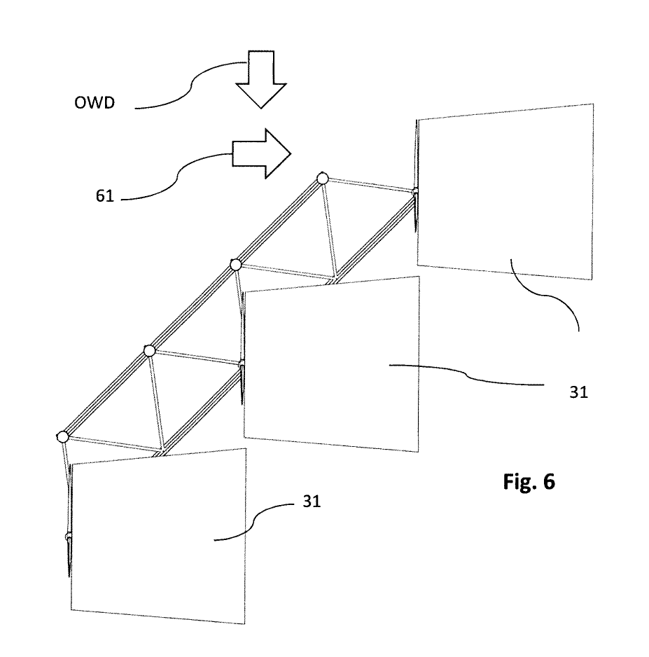

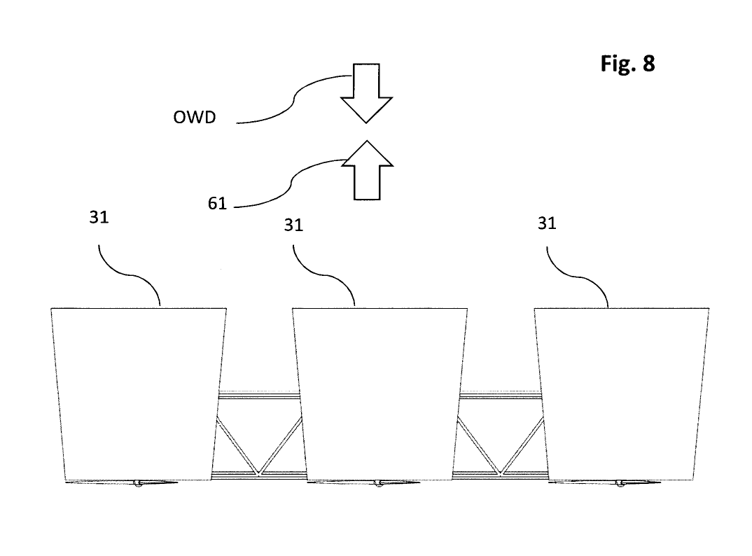

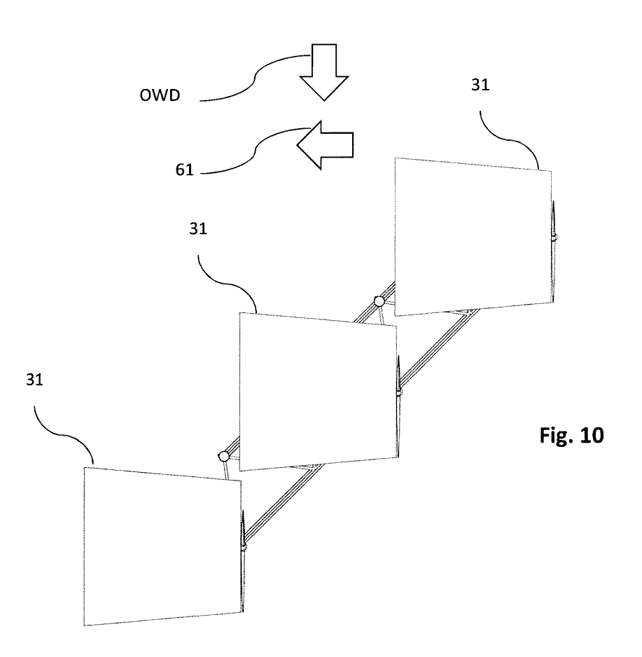

For application areas where wind turbines are arranged for example substantially in a line, such as shown in FIG. 3, the distance between two wind turbines is determined by the least favorable wind direction 61. For example, any wind direction 61 that is substantially perpendicular to the line of arranged wind turbines, such as illustrated in FIG. 4 or FIG. 8, the distance between the wind turbines can be relatively short. However, if the wind direction changes to the direction of the line, i.e. the wind direction as shown in for example FIG. 6 or FIG. 10, the wakes 31 would be projected directly towards the next wind turbine generating a requirement for the distance between the wind turbines to be significantly increased. The relation determining the distance between turbines could be described by the formula:

$$L = \frac{D}{( 1 - sin ( x ) ) sin ( v )}$$

wherein ‘L’ is the distance between the wind turbines, ‘D’ is the diameter of the rotor components, ‘x’ is scattering angle of the wake, and ‘ν’ is the rotation angle of the nacelle (0-90°) from the original nacelle position where the rotating blades of the rotor component are parallel to the elongation direction of the platform. By decreasing the nacelle rotation rate to only cover the range in said first and second sectors and instead rotate the platform the remaining degrees until the rotor components of the wind turbines are aligned to be essentially perpendicular to the wind direction, or to rotate the platform to cover the range in the first and second sectors and rotate the nacelle the remaining degrees until the rotor components of the wind turbines are aligned to be essentially perpendicular to the wind direction, as in the present invention, the distance required between the wind turbines is significantly decreased.

This is now illustrated with reference to the accompanying figures

$$L = \frac{D}{( 1 - sin ( 5 ° ) ) sin ( 45 ° )} \approx 1.55 \times D$$

For conventional multi-turbine power production platforms the distance between the wind turbines in general are around five times the diameter of the rotor component in order to reduce the interference between the wakes and rotor components.

As can be seen in the formula above the distance of 1.55×D between the wind turbines is based upon a maximum of 45° rotation of the nacelle. Thus, a combined rotation of the platform of ±45° is necessary to cover all wind directions. Therefore, the optimum distance between the wind turbines also depend on the allowed maximum rotation of the platform. The rotation of the platform move the geographic position of the wind turbines and improve their position in relation to the wind direction so that they always operate in undisturbed wind.

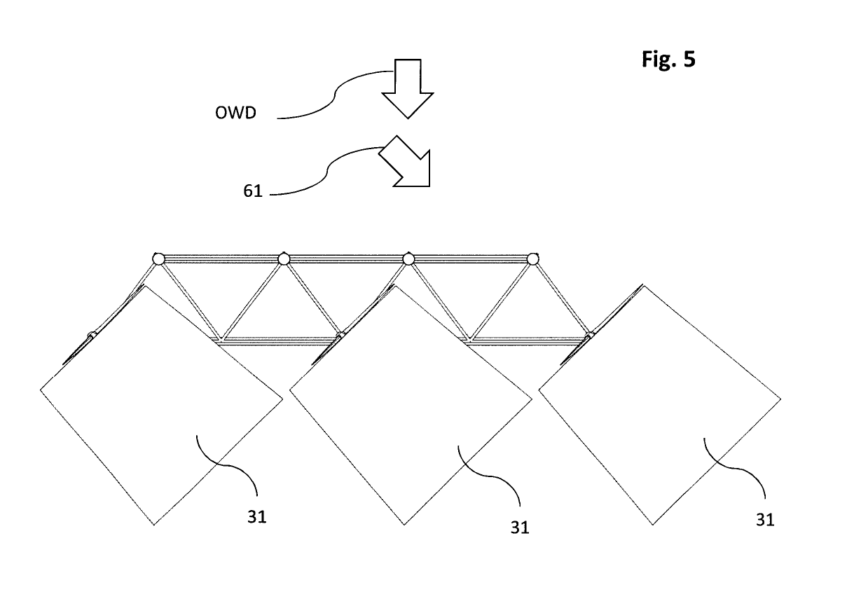

The multi-turbine wind power platform utilizes two different means in order to align the rotor component with the wind direction. The person skilled in the art understands that the wind might turn 360° from the original wind direction position and that it is beneficial for the power production to enable power production independent of the wind direction. In order to describe the benefits of the floating multi-turbine wind power platform the 360° are divided into four substantially equal virtual sectors 141-144 where the first sector 141 covers ±45°, the second sector 142 covers 135°-225°, the third sector 143 covers 45°-135°, and the fourth sector 144 covers 225°-315° from the original position located at 0°. In addition, an original nacelle position is also defined as the position wherein the rotor component of each nacelle is rotated to be in parallel to the extension direction of the platform when the platform is in its original position. I.e. in one embodiment of the floating multi-turbine wind power platform wherein the power production is active the original platform position, original wind direction position, and the original nacelle positions are aligned, see FIG. 4. However, in another embodiment, see FIG. 5, when the wind direction for example has turned 45° from the original wind direction the platform can still be located at 0° in its original platform position while the nacelles has turned 45° from the original nacelle position in order to align the rotor components with the wind direction. With a wind direction 45° from the original wind direction, as in FIG. 5, it is also possible to instead rotate the platform 45° and let the nacelles remain unrotated. In one embodiment, it is of course also possible to combine nacelle and platform rotation also when the wind blows from the first or second sector 141, 142. The original nacelle position is thereby not dependent on the platform position since if the platform is rotated 45° from its original position and the nacelles are rotated 45° from its original position the rotor components are at 90° from the original wind direction, see FIG. 6. However the original wind direction position of 0° is substantially the same as the original platform position at 0° in relation to for example a compass bearing.

The original position as used herein is the general position wherein the original nacelle position, the original platform direction, and the original wind direction position align.

The platform may be part of a system comprising means for controlling the alignment of the rotor components of the wind turbines to be essentially perpendicular to the wind direction for rotation. Said means is adapted to control the rotation of the platform 1 and the nacelle 5 depending on received information about an actual wind direction. This means may be the control arrangement C described above. The actual wind direction 61 may be measured by means for determining the actual wind direction, for example a wind meter arranged on the platform, or received from weather forecasts or other sources. The system may further comprise means for relating said actual wind direction to an original wind direction defined as a direction being essentially perpendicular to the elongation direction of the platform when in the original position. In one embodiment said means for controlling the alignment controls two different means for rotation MR1, MR2 which cooperate to align the rotor components of the wind turbines to be essentially perpendicular to the wind direction. Said two means are; first means for rotation of the platform MR1 and second means for rotation of the nacelle MR2. When wind is measured to blow from different wind direction the different means are used for alignment. The rotation of the platform is controlled by control arrangement C arranged to control the means for rotation of the platform MR1 to rotate the platform only during certain detected wind directions deviating from the original wind direction OWD and to limit the rotation of the platform 1 to at the most 90° from the original position, preferably at most ±45°. The rotation of the nacelle 5 may also be controlled by the control arrangement C.

The aligning is in one embodiment conducted through the steps of:

rotating said nacelles from an original nacelle position or rotating said platform from an original platform position or rotating both the nacelle and the means for platform to a position where the rotor components are aligned with different wind directions within the first or second sector 141, 142,

rotating in combination said nacelles and said platform from an original platform position aligning the rotor components with different wind directions within a third and fourth sector 143, 144.

In one embodiment the first and second sectors 141, 142 are sectors which through nacelle rotation or platform rotation solely enable the rotor components to be aligned to the wind directions within the first and second sectors. Within those sectors nacelle rotation is sufficient without interference occurring between the wakes and rotor components of the multiple wind turbines. In another embodiment the first and second sectors 141, 142, a combination of nacelle and platform rotation may be used.

In one embodiment of the floating multi-turbine wind power platform the third and fourth sectors 143, 144 are sectors wherein the rotor components are aligned with the wind direction through a combination of nacelle rotation and platform rotation.

When the wind blows from a direction within the first sector 141 defined as approximately ±45° from the original wind direction OWD or the second sector 142 defined as approximately 135°-225° from the original wind direction OWD, only the nacelle is rotated by activation of the second means for rotation MR2 or only the platform is rotated by activation of the first means for rotation MR1. In one embodiment both the nacelle and the platform are rotated slightly. When the wind blows from wind directions within the third sector 143 defined as approximately 45°-135° from the original wind direction OWD and the fourth sector 144 defined as approximately 225°-315° from the original wind direction OWD, both the nacelle and the platform is rotated by activation of both the first and the second means for controlling the rotation MR1, MR2. Thus, both the nacelle and the platform is rotated. The platform is rotated a maximum of 90°, preferably at most approximately ±45°, from the original platform position and the nacelle is rotated the remaining degrees until the rotor components are aligned to be essentially perpendicular to the wind. The angle intervals of the respective first, second, third and fourth sectors are defined based on a maximum ±45° rotation of the platform from the original platform position.

FIG. 4 illustrates a first wind situation of the invention wherein the wind direction 61 is from a direction of 0°, i.e. in an original wind direction position which is substantially ideal for and corresponding to the original position of the platform 1. The original wind direction may also be defined as a direction being essentially perpendicular to the elongation direction of the platform when in the original position. For this wind direction the nacelles are rotated to 0° from their original position and the platform is in its original position. Note that herein the rotation is measured in clockwise degrees, i.e. 0-360° based on a clockwise rotation.

FIG. 5 illustrates a second wind situation wherein the wind direction 61 has turned 45° counter clockwise to a position of 315° clockwise from an original wind direction OWD. For this wind direction the nacelles are rotated 315° or at least −45° (counter clockwise) from an original position and located within the first sector. With a wind direction 45° from the original wind direction, as in FIG. 5, it is also possible to instead rotate the platform −45° and let the nacelles remain unrotated or to combine a rotation of the platform and a rotation of the nacelle, for to rotate the platform −30° and the nacelle −15°.

FIG. 5 clearly illustrates how the wakes 31 projection direction do not interfere but that this is close to the maximum rotation that is possible without interference occurring, which also is the reason for the first sectors limit at 315°.

FIG. 6 illustrates a third wind situation wherein the wind direction 61 has turned another 45° counter clockwise to a position of 270° clockwise from an original wind direction OWD. For this wind direction 61 the nacelles are maintained at their rotation of 315° or −45° from the original nacelle position and in addition the platform is rotated −45° from the original platform position. Thereby the rotation degree between the wind turbines is maintained and interference between the wakes and rotor components is avoided.

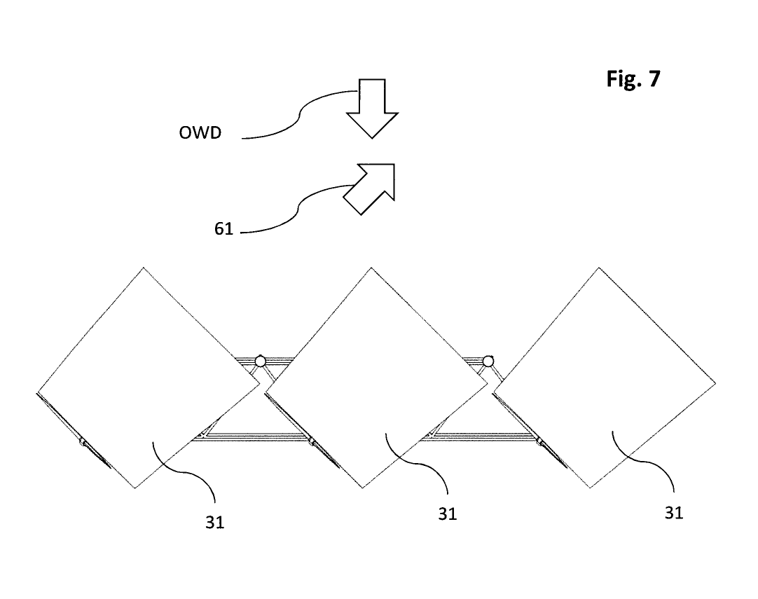

FIG. 7 illustrates a wind situation embodiment wherein the wind direction 61 has turned yet another 45° counter clockwise to a position of 225° clockwise from an original wind direction OWD. For this wind direction the nacelles are rotated 225° or −135° from an original nacelle position and the platform is positioned at the original platform position of 0°. With a wind direction of 225° clockwise from an original wind direction OWD, as in FIG. 7, it is also possible to instead rotate the platform 45° and let the nacelles remain unrotated.

FIG. 8 illustrates a fifth wind situation wherein the wind direction 61 has turned to 180° from the original wind direction OWD. The nacelles are thereby also turned to 180° from the original nacelle position meanwhile the platform is placed in its original platform position.

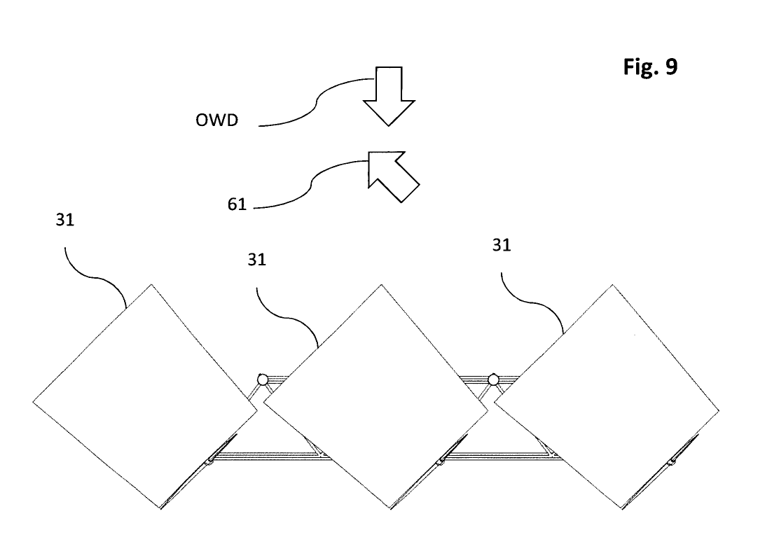

FIG. 9 illustrates a sixth wind situation wherein the wind has turned to 135° from an original wind direction OWD. The nacelles are also turned to 135° from the original nacelle position meanwhile the platform is placed in its original position. With a wind direction of 135° clockwise from an original wind direction OWD, as in FIG. 9, it is also possible to instead rotate the platform −45° and rotate the nacelles 180°.

FIG. 10 illustrates a seventh wind situation wherein the wind has turned to 90° from an original wind direction OWD. The nacelles are turned to 135° from an original nacelle position and the platform is rotated −45° from its original position. It is also possible that the platform rotates +45° from its original position and the nacelles are turns +45° from their original nacelle position

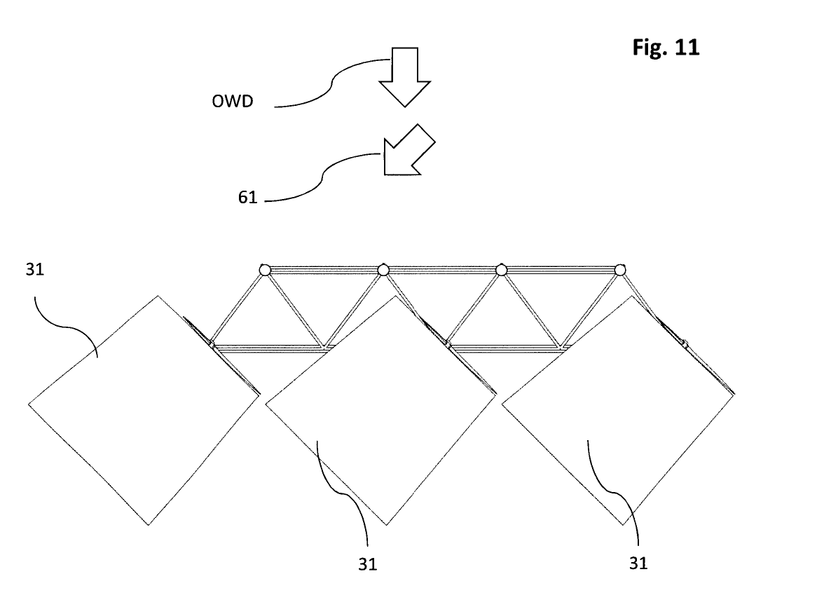

FIG. 11 illustrates an eighth wind situation wherein the wind has turned to 45° clockwise from an original wind direction OWD. The nacelles are turned to 45° from an original nacelle position meanwhile the platform is placed in its original position. It is also possible to only rotate the platform 45° from its original position and let the nacelle remain in their original position.

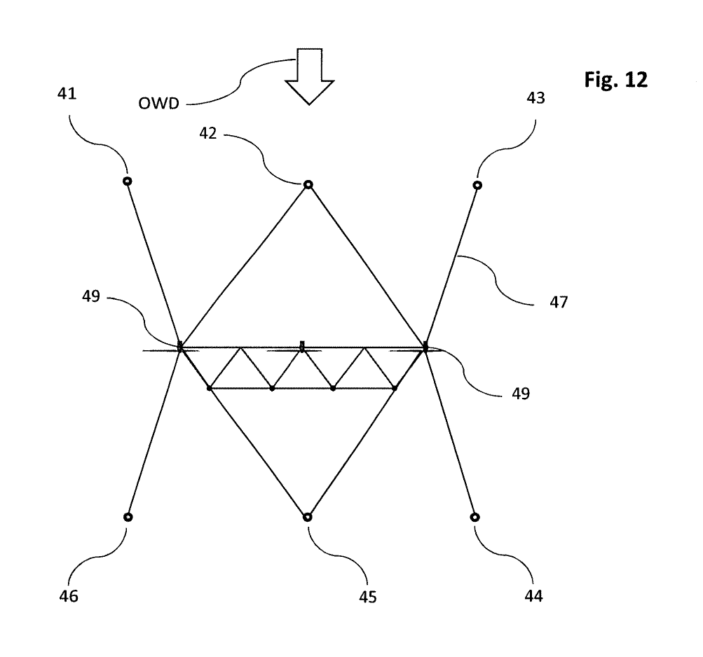

FIG. 12 illustrates one embodiment of the wind power platform 1 for multiple wind turbines wherein said platform 1 is attached to six mooring points 41-46 which are adapted to secure the platform at its operation site by means of attachment means 47. Said attachment means 47 are attached to said platform in at least two platform connection points 49. The person skilled in the art understands that the attachment means 47 may be any form of attachment means, including but not limited to, wires, chains, ropes, and belts. The person skilled in the art further understands that the number of mooring points can be any number of mooring points serving the same purpose as the mooring points illustrated in FIG. 12.

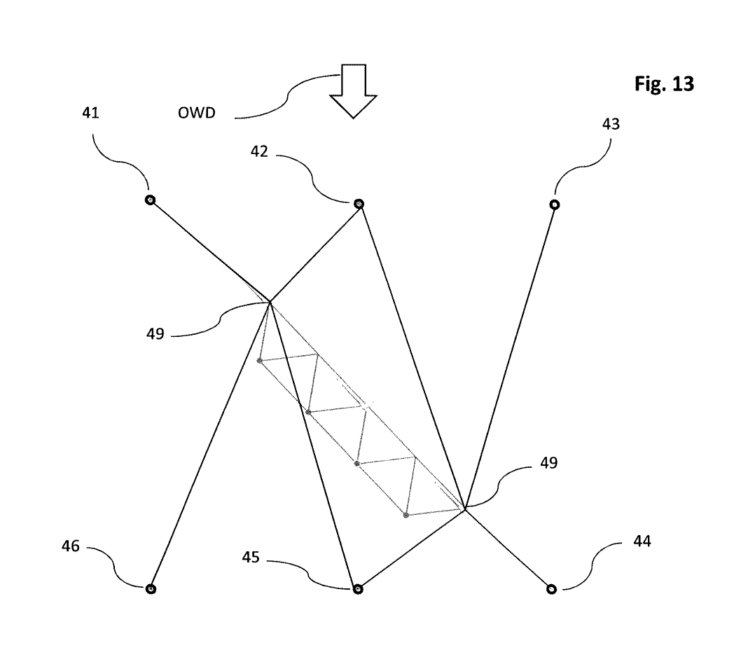

In the embodiment as illustrated in FIG. 12 the platform 1 is positioned in an original platform position wherein the distance preferably is substantially equal to all mooring points 41-46. The platform 1 is rotatable with ±45° from said original position as illustrated for example in FIG. 13.

FIG. 13 illustrates the embodiment of FIG. 12 wherein the platform is rotated 45° from its original position. The rotation may in different embodiments of the invention be conducted with means of different rotation arrangements, for example controlled by the control arrangement C. However, in one embodiment, the means for rotation of the platform MR1 comprises for example two winches arranged to move at least one platform connection point 49 along the length of said attachment means 47. The platform is winched along said attachment means 47 in order to rotate the platform 1 in relation to its original position. The length of the attachment means 47 is in this embodiment kept constant. Other possible but not shown means for rotation of the platform MR1 may be thrusters or other engines rotating the platform combined with mechanical means locking the rotation at the maximum 90° from its original position. It is also possible to use winches adjusting the relative length of the attachment means 47 accordingly.

FIG. 14 shows a principal sketch of the four sectors 141-144 in relation to the wind turbine are illustrated. The sectors are divided based on the original position of 0° as previously described as the starting point and with a range of 360° from this position. The first sector 141 covers the range between 315° and 45°, the second sector 142 covers the range between 135° and 225°, the third 143 sector covers the range between 45° and 135°, and the fourth sector 144 covers the range between 225° and 315°. In the first and second sector 141, 142 said means for rotation of the platform MR1 or the means for rotation of the nacelle MR2 are used to align the rotor components to be essentially perpendicular to the wind. In the third and fourth sector 143, 144 said means for rotation of the platform MR1 and the means for rotation of the nacelle MR2 are used together to align the rotor components to be essentially perpendicular to the wind.

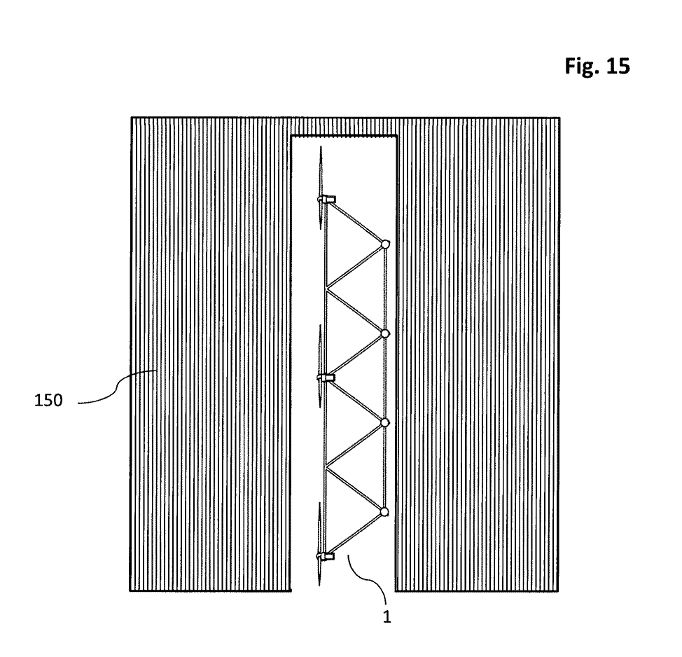

FIG. 15 illustrates the floating multi-wind turbine platform 1 within a general shipyard dry dock 150 which can be used for example for assembly or maintenance of the platform 1.

However, the floating multi-wind turbine power platform 1 is not limited to assembly in a dry dock. The floating draught of the platform 1 through the innovative elongated enlarged pontoon bar 7 systems enables production of the platform 1 almost anywhere. After assembly the platform can easily float out from the assembly location without any significant water depth. This means that the platform 1 in one embodiment for example could be assembled on a boat carriage, slip, dry dock, bank, seashore, or any other suitable location in the close vicinity of the ocean.

The size and dimension that are significantly different from the prior art solutions also provide the advantage that the platform 1 can be transported through other sea routes, such as the Panama Canal or the Suez Canal. Such sea routes have limitations for vessels passing through. This decrease the relocation time for platforms traveling in waters where those channels are the best transportation route.

The person skilled in the art understands that the measurements might change if locks are replaced, bridges changed, or other measurements are taken to change the characteristics of the canals. Thus, the invention is not limited to the current measurements.

However, the current measurements are:

| | |
|---|---|
| Suezmax: | Panamax: |

| | | | |
|---|---|---|---|
| Width: | 50 m | Width: | 32.3 m |
| Length: | unlimited | Length: | 294.13 m |
| Draught: | 20.1 m | Draught: | 12.04 m |
| Air draft: | 68 m | Air draft: | 57.91 m |

It should be noted that in the detailed description above any embodiment or feature of an embodiment are only examples and could be combined in any way if such combination is not clearly contradictory.

1. A floating multi-turbine wind power platform for offshore power production, wherein said platform is having a substantially elongated shape with an extension direction and being attached to at least two mooring points adapted to secure the platform at its operation site in an original position in relation to said mooring points by means of attachment means connected to said platform in at least two platform connection point, said platform comprises means for rotation of the platform (MR1) around an essentially vertical first axis (z1) and further comprise at least two wind turbines arranged substantially in a straight line corresponding to the extension direction of the platform and said at least two wind turbines each comprises a structural support component and a rotor component arranged to rotate around an essentially horizontal axis (x), said rotor component is attached to a nacelle which is arranged to rotate around an essentially vertical second axis (z2) using means for rotation of the nacelle (MR2) wherein the platform comprises a control arrangement (C) arranged to control the means for rotation of the platform (MR1) to rotate the platform only during certain detected wind directions deviating from an original wind direction (WDO) defined as a direction being essentially perpendicular to the elongation direction of the platform when in the original position and to limit the rotation of the platform to at the most 90° from the original position, preferably at most ±45°.

2. The floating multi-turbine wind power platform for offshore power production according to claim 1, wherein said means for rotation of the nacelle (MR2) and the means for rotation of the platform (MR1) is adapted to cooperate to align the rotor components of the wind turbines to be essentially perpendicular to a detected actual wind direction.

3. The floating multi-turbine wind power platform for offshore power production according to claim 2, wherein the means for rotation of the nacelle (MR2) or the means for rotation of the platform (MR1) is adapted to solely be used or used together for aligning the rotor components of the wind turbines to be essentially perpendicular to the actual wind direction, when the wind blows from wind directions within a first sector defined as approximately ±45° from the original wind direction or a second sector defined as approximately 135°-225° from the original wind direction and wherein the means for rotation of the nacelle (MR2) is adapted to cooperate with the means for rotation of the platform (MR1) for aligning the rotor components of the wind turbines to be essentially perpendicular to the actual wind direction, when the wind blows from wind directions within a third sector defined as approximately 45°-135° from the original wind direction and a fourth sector defined as approximately 225°-315° from the original wind direction, so that said platform rotates a maximum of 90°, preferably at most approximately ±45°, from the original platform position and the nacelle rotates the remaining clockwise degrees until the rotor components are aligned to be essentially perpendicular to the actual wind direction.

4. The floating multi-turbine wind power platform for offshore power production according to claim 1, wherein said means for rotation of the platform (MR1) comprises at least two winches arranged to move at least one platform connection point along the length of said attachment means.

5. The floating multi-turbine wind power platform for offshore power production according to claim 1, wherein said platform is a truss structure comprising at least two spaced apart substantially elongated pontoon bars attached to a lower section of said platform, said elongated pontoon bars are enlarged pontoon bars adapted to act as floatation pontoons during transportation and/or maintenance.

6. The floating multi-turbine wind power platform for offshore power production according to claim 1, wherein said enlarged pontoon bars further are adapted to act as ballast tanks.

7. The floating multi-turbine wind power platform for offshore power production according to claim 1, wherein the space between adjacent wind turbines is between one and three times the rotor component diameter, preferably 1.55 times the rotor diameter.

8. The floating multi-turbine wind power platform for offshore power production according to claim 1, wherein the width, beam and draft, of said platform is within the limits of Suezmax, preferably within the limits of Panamax.

9. A method for aligning rotor components of wind turbines arranged on a floating multi turbine wind power platform according to claim 1, to be essentially perpendicular to a wind direction, wherein it comprises the steps of:
Determining an actual wind direction
Relating said actual wind direction to an original wind direction defined as a direction being essentially perpendicular to the elongation direction of the platform when in the original position
Controlling the rotation of said platform based on the actual wind direction and limiting the rotation of the platform to at the most 90° from the original position, preferably at most approximately ±45°
Aligning the rotor components of the wind turbines to be essentially perpendicular to the actual wind direction using the means for rotation of the nacelle (MR2) and/or the means for rotation of the platform (MR1)

10. A method according to claim 9 wherein, when the wind blows from wind directions within a first sector defined as approximately ±45° from the original wind direction or a second sector defined as approximately 135-225° from the original wind direction; using means for rotation of the nacelle (MR2) to rotate only the nacelle or using means for rotation of the platform (MR1) to rotate only the platform or use both the means for rotation of the nacelle (MR2) and the means for rotation of the platform (MR1) to align the rotor components to be essentially perpendicular to the wind direction when the wind blows from wind directions within a third sector defined as approximately 45-135° from the original wind direction and a forth sector defined as approximately 225-315° from the original wind direction; using means for rotation of the nacelle (MR2) together with means for rotation of the platform (MR1) to rotate the platform a maximum of 90°, preferably at most approximately ±45°, from the original platform position and rotating the nacelle the remaining degrees until the rotor components are aligned to be essentially perpendicular to the wind direction.

11. The method of aligning rotor components of wind turbines arranged on a floating multi turbine wind power platform to be essentially perpendicular to a wind direction according to claim 9, wherein the method further comprises the step of:
winching said platform along the attachment means and thereby rotating the platform.

12. A system for aligning rotor components of wind turbines arranged on a floating multi turbine wind power platform according to claim 1, to be essentially perpendicular to a wind direction characterized in that it comprises:
Means for determining an actual wind direction
Means for relating said actual wind direction to an original wind direction defined as a direction being essentially perpendicular to the elongation direction of the platform when in the original position
Means for controlling the aligning the rotor components of the wind turbines to be essentially perpendicular to the actual wind direction by controlling the means for rotation of the nacelle (MR2) and/or the means for rotation of the platform (MR1)

13. The floating multi-turbine wind power platform for offshore power production according to claim 2, wherein said means for rotation of the platform (MR1) comprises at least two winches arranged to move at least one platform connection point along the length of said attachment means.

14. The floating multi-turbine wind power platform for offshore power production according to claim 3, wherein said means for rotation of the platform (MR1) comprises at least two winches arranged to move at least one platform connection point along the length of said attachment means.

15. The floating multi-turbine wind power platform for offshore power production according to claim 2, wherein said platform is a truss structure comprising at least two spaced apart substantially elongated pontoon bars attached to a lower section of said platform, said elongated pontoon bars are enlarged pontoon bars adapted to act as floatation pontoons during transportation and/or maintenance.

16. The floating multi-turbine wind power platform for offshore power production according to claim 3, wherein said platform is a truss structure comprising at least two spaced apart substantially elongated pontoon bars attached to a lower section of said platform, said elongated pontoon bars are enlarged pontoon bars adapted to act as floatation pontoons during transportation and/or maintenance.

17. The floating multi-turbine wind power platform for offshore power production according to claim 4, wherein said platform is a truss structure comprising at least two spaced apart substantially elongated pontoon bars attached to a lower section of said platform, said elongated pontoon bars are enlarged pontoon bars adapted to act as floatation pontoons during transportation and/or maintenance.

18. The floating multi-turbine wind power platform for offshore power production according to claim 2, wherein the space between adjacent wind turbines is between one and three times the rotor component diameter, preferably 1.55 times the rotor diameter.

19. The floating multi-turbine wind power platform for offshore power production according to claim 3, wherein the space between adjacent wind turbines is between one and three times the rotor component diameter, preferably 1.55 times the rotor diameter.

20. The floating multi-turbine wind power platform for offshore power production according to claim 4, wherein the space between adjacent wind turbines is between one and three times the rotor component diameter, preferably 1.55 times the rotor diameter.
